(19) United States
(12) Patent Application Publication
(10) Pub. No.: US 2003/0060920 A1
(43) Pub. Date: Mar. 27, 2003

(54) Detection of vibrations in mechanical systems

(76) Inventors: Lev Kishlyansky, Thornhill (CA); Mikhail Binder, Thornhill (CA); Heorhi Abramchuk, Toronto (CA); Miheli Cluzman, Toronto (CA)

Correspondence Address: Anthony ASQUITH, 173 Westvale Drive, Waterloo, ON, N2T 1B7, CA

(21) Appl. No.: 10/254,590

(22) Filed: Sep. 26, 2002

(30) Foreign Application Priority Data
Sep. 26, 2001 (GB) 0123130.7

(51) Int. Cl. G06F 19/00

(52) U.S. Cl. 700/175; 700/280; 702/56

(57) ABSTRACT

A method of measurement random wave and vibration processes in mechanical system with distributed parameters is disclosed. The methodical problem solution of recognition the condition of a cutting tool (identification micro- and macro-destructions) in cutting process is given. As an example is described the real time measuring and control expert system realising given algorithms of detecting the condition of a cutting tool during cutting process. As a means of measurements the measuring transducer is offered, in which one as the sensor the accelerometer can be used.

### BACKGROUND OF THE INVENTION

This invention is related to monitoring and identifying vibratory signals in machine tools, principally in order to detect metal cutting tool damage, and is aimed at differentiating these signals from spurious signals not related to tool damage. The invention is also aimed at providing an associated measuring system.

The problem of detecting tool damage and breakage has been studied for many years, and various devices and systems for this application are available on the market. An aim of the invention is to improve the reliability and speed with which tool breakage events are detected and indicated. It is also an aim to provide a system that will detect the onset of an imminent breakage event, early enough for precautions to be taken that will prevent damage to the workpiece.

U.S. Pat. Nos. 4,642,617 4,636,779 5,319,357 5,298,889 5,407,265 5,187,669 5,579,232 5,251,144, describe methods of receiving information about cutting tool condition, as does the publication “Sensor Signal For Tool Monitoring in Metal Cutting Operations-Review of Methods”, by D. E. Dilma Snr, International Journal of Machine Tool Manufacturing (2000) 40, pp. 1073-1098. These methods utilize accelerometers as the source of information about physical and mechanical processes which take place in various tools during their dynamic interaction with the workpiece, during the cutting process (turning, drilling, milling, etc.). These accelerometers convert physical and mechanical processes into electrical signals within a wide range of amplitudes and frequencies.

The emphasis in these known systems is on the manner of processing the signal information received from the various accelerometers. Some additional expensive and extensive researches have been required, to identify the structure and types of the received signals, to determine methods of retrieving information related to cutting tool damage. Generally, the result is a complicated and difficult-to-realize algorithm. The relevant art includes U.S. Pat. Nos. 5,579,232; 6,301,572 and “Review-Prospects for In-process Diagnosis of Metal Cutting by Monitoring Vibration Signal”, M. Y. Lee, C. E. Thomas, G. Wildes, Journal Mathematical Science (1987), v.22, pp.3821-3890; “On-line Metal Cutting Tool Condition Monitoring”, D. E. Dilma Sr., P. M. Lister, International Journal Machine Manufacturing (1997), vol.37, pp. 1219-1241; and “Automated Monitoring of Manufacturing Processes”, R. Du, M. A. Elbestawi, S. M. Wu (1995), Journal of Engineering for Industry, vol. 117,pp. 121-141).

Accelerometers, as signal sources, have been mounted in different ways on the machine tool parts. Generally, their location has been determined experimentally, individually for every type of machine tool. The following general teachings may be recognised.

1. The accelerometer should be located where the vibrations generated by the cutting-tool can be readily transmitted. The greater the distance the vibrations have to travel, in order to reach the sensor, the more the signals may be subject to deterioration and weakening. Also, the geometrical configuration, mechanical links, etc, between the signal source and the accelerometer, can affect the reliability with which the sensor picks up the vibrations.

2. Sometimes, sources of spurious vibrations may be present in the machine tool, in an area whereby the false vibrations are picked up by the accelerometer. The approach to this problem has tended to be hardly more than an admonition to place the accelerometer in a place where the interference from spurious acoustic signals is less.

3. The accelerometer and its connections should be physically protected.

4. Attention should be given to linear sizes of accelerometers and information processing channels.

5. Attention should be given to dimensional accessibility to measuring channel elements, the accelerometer and the integrated electronic block being physically small relative to machine tool elements.

The tool monitoring systems as described herein differ from the above in (some of) the following respects:

in the manner of taking information about vibrations emanating from the cutting tool, using a measuring transducer;

in the manner of locating this transducer on the machine tool element;—in a new algorithm for processing the vibration information;—in combining the above to provide new functions of monitoring, detecting, and identification of micro and macro breakage of the cutting tool, during the metal cutting process.

It is an aim of the invention to improve the following functions:

trueness of signal measurement and identification;

resolution and sensitivity of the sensor to physical and mechanical vibrations taking place in the cutting zone; with the aim that these measurements can be used to indicate the onset of micro and macro breakage of the cutting tool.

One of the aims of the invention is to enhance the accuracy and productivity of the metal cutting process, by minimizing operator involvement while operating CNC machine tool. Some other aims are:

to develop optimal methods of detecting micro and macro breakage of the cutting tool;

to Justify optimal criterions for reliable identification of signals generated by tool insert damage during metal cutting process from those produced by other sources.

to provide engineers with a reliable system for the detection and identification of tool damage.

to detect differences between minimum and maximum damage, which may cause substantial deterioration of the component accuracy and surface finish;

to reduce system learning curves at all stages;

to develop a full adaptive control system for the metal cutting process.

It may be noted that the orientation of the accelerometers in relation to the signal sources, which is of significant methodological importance, is not described in the prior art. The matter of dimensional orientation of the accelerometer and its influence on signal receiving quality have not been considered.

### BRIEF DESCRIPTION OF THE DRAWINGS

In the accompanying drawings:

FIG. 1 is a diagram of a component of a machine tool, being a toolpost, in which vibratory waves are processed, in the manner of the invention.

FIG. 2 is a block diagram showing how the vibrations are processed.

FIG. 3 is a side elevation of a vertical boring machine, which includes the toolpost of FIG. 1, in which vibratory signals emanating from a cutting interface are being processed.

FIG. 4 is a block diagram showing how the signals from a vibration sensor are processed by a tool breakage detection system.

FIG. 5 is a trace, showing a typical signal produced by normal cutting, showing the noise of measuring channel of the tool breakage detection system.

FIG. 6 is a trace showing different cutting conditions, being: noise of the measuring channel;

start of the cut;

normal cutting;

a signal that a tool breakage event has occurred;

cutting with a broken tool.

FIG. 7 is another trace, showing a tool breakage event.

FIG. 8 is a block diagram of the tool breakage detection system, including software.

FIG. 9 is a diagram showing an accelerometer, and the manner in which it is mounted to the toolpost.

### DETAILED DESCRIPTION OF THE EMBODIMENTS

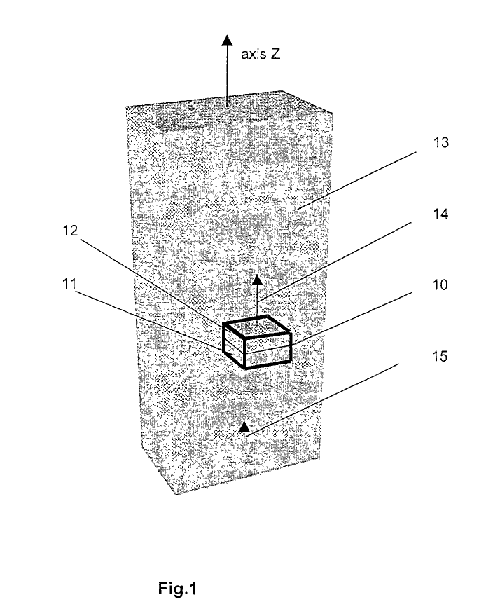

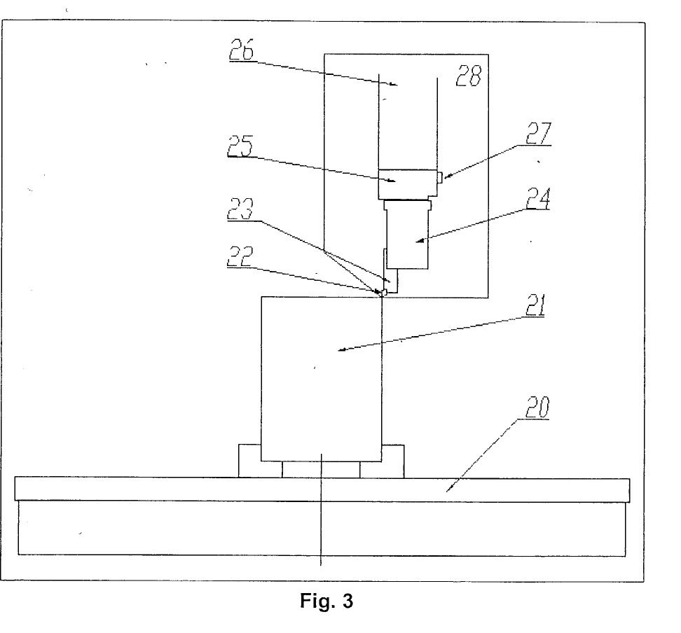

The machine tool shown in FIGS. 1 and 3 has a component or element 13, which in this case is the toolpost of a vertical boring machine. The invention aims to measure dynamic processes (wave and vibrations) which enables information to be retrieved about the cutting process, the information being necessary and sufficient for monitoring, identification, and detection of micro and macro tool breakage and vibrations during metal cutting. This information is retrieved from the physical and mechanical vibrations that take place in the contact area of the cutting tool on the workpiece.

This method is based on the following: measuring converter 10 is mounted on element 13 of mechanical system. This measuring converter 10 consists of at least two elements: motion transformer 11 and accelerometer 12, rigidly installed on it. Measuring converter 10 is dimensionally located in the manner to ensure that its main axis of sensitivity coincides with main vector 15 of the waves in element 13 of mechanical system.

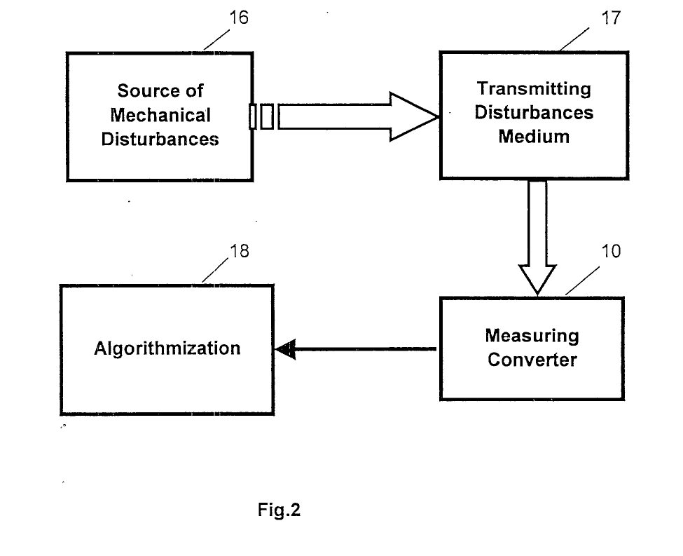

Source of mechanical disturbances 16 (see FIG. 2) passes a dynamic process to the measuring converter 10 through transmitting disturbance medium 17.

Measuring transducer 10 converts mechanical process taking place in element 13 of mechanical system into electrical signals, which reflect these physical/mechanical processes. Motion transformer 11 (see FIG. 1) processes these physical/mechanical actions. Accelerometer 12 identifies and measures mechanical process, which has been processed by motion transformer 11. Electrical signal from measuring transducer 10 undergoes algorithmization including signal processing 18 (see FIG. 2).

This working of this method may be illustrated using the following example (refer to FIG. 3): Workpiece 21 is clamped on table 20. Working units of machine tool start to move, and certain physical and mechanical processes (vibratory waves) are generated in the area of contact of cutting tool insert 22 and workpiece 21. These processes spread in the mechanical system 28, which includes cutting insert 22, cutting tool 23, tool holder 24, ram bottom plate 25, and ram 26. They also actuate measuring converter 27.

Mechanical system 28 is an acoustic equivalent of element 13 of mechanical system, described above and marked on FIG. 1. The optimal location of measuring converter 27 is where there is minimal weakening and distortion of physical/mechanical processes generated in the cutting zone. In our example, measuring converter 27 is rigidly installed as close as reasonably possible to the source of signals, i.e. on ram bottom plate 25 of mechanical system 28.

Measuring converter 27 is orientated in the way to make sure that its main sensitivity axis is coaxial with the Z-axis (the Z-axis being the vertical axis, by convention, in a vertical boring machine) of the ram 26. The elements of mechanical system 28 are acoustically coordinated. Measuring converter 27 posses a wide band. Its transmission band with sufficient accuracy overlaps the transmission band of mechanical system 28 for information signals, i.e. signals containing information about cutting process, dynamic changes in low frequency range of the mechanical system, about micro and macro breakage and vibrations. Process of cutting is dynamic process. This information can be utilized for an adaptive control, optimization of cutting process, and an operation of a machine tool.

Measuring converter 27 and its electrical connections with other elements of the electrical circuit have special protection from mechanical actions caused by cutting process, including chips. Physically, the protection is made in a way to eliminate any acoustic distortion in the location of measuring converter 27. The design of measuring converter 27 and its protection does not change dynamic specifications of mechanical system 28 of the machine tool within full range of its frequencies.

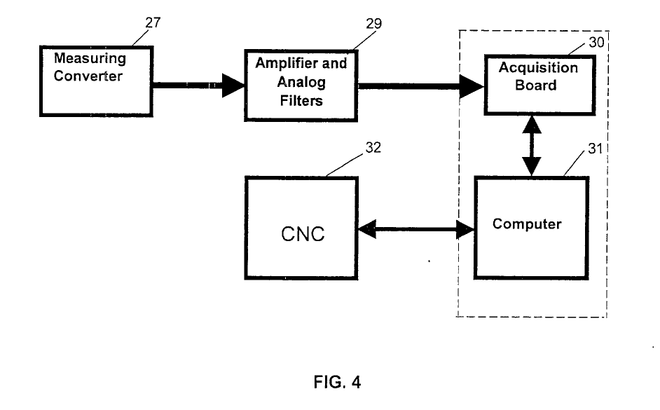

During cutting process, measuring transducer 27 converts physical/mechanical processes taking place in the cutting zone into electrical signals. These electrical signals are transmitted to amplifier and analog filter 29 and then, through connection lines, to acquisition board 30 directly connected to computer 31 (refer to FIG. 4). Computer 31 and machine CNC 32 are connected by high-speed communication channel. The structure of machine tool measuring and control system is outlined in FIG. 4.

Intellectual measuring and control system is able to effect monitoring, signal identification, reflecting the above processes in the cutting zone, as well as actual condition of the cutting tool. When the tool is broken, it is retrieved from the cutting zone, replaced, and returned to resume cutting. All this is done in real time format and according to appropriate algorithms.

Since the measuring procedure includes as a significant part the mechanical displacement transformer, the electrical signal became easier to analyze by computer program.

The technical method of organizing flow of information in buffers has several advantages:

Processing each buffer independently decreases the maximum delay between the actual event when tool breakage took place and recognition it in data flow to the value of buffer's length in time scale.

It does not require a dip process information history for analyze that means it is less sensitive relatively partially lost data.

Thus a bipolar signal carries the information, it is easier to discard one polar noise caused by outside electrical source. From this point of view, the shorter the buffer the less the probability to have two electrical impulses with different signs. To achieve this, each buffer may be processed as follows:

Determine the minimum and maximum value of the signal for current buffer.

If they have the same sign, the buffer does not content a breakage event.

Find the minimum of absolute values of them.

Compare the said value with a threshold value for tool breakage.

If it is greater, tool breakage took place in current buffer.

Damping factors in the tool breakage process more or less guarantee that there will be at least two oscillations with the amplitude greater than the value of threshold value for tool breakage. It does not matter if the tool breakage process will be splinted into two sequent buffers. At least one of them will have a bipolar oscillation with the said amplitude.

In monitoring mode, measuring converter 27 transforms physical/mechanical processes in the cutting zone into by-polar electrical signals, which substantially facilitates further procedures related with signal processing.

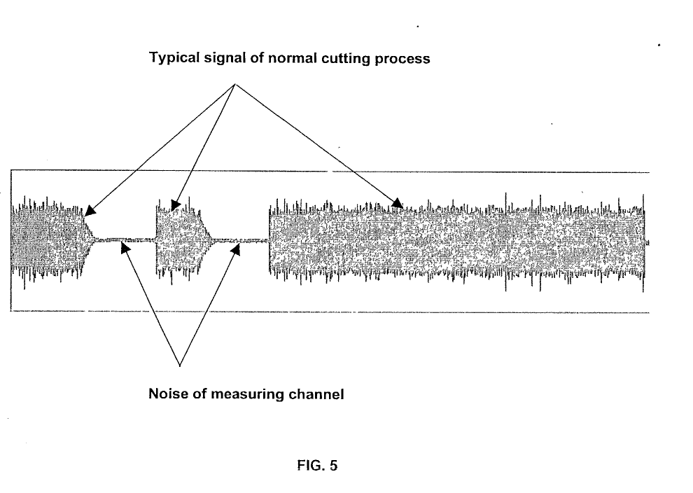

FIG. 5 shows typical electrical signal generated in the cutting zone and converted by measuring transducer 27 (all cutting parameters—cutting depth, feed and speed—conform to cutting insert and tool manufacturers' standards). For comparison, FIG. 5 also shows electrical noise of measuring channel of the system.

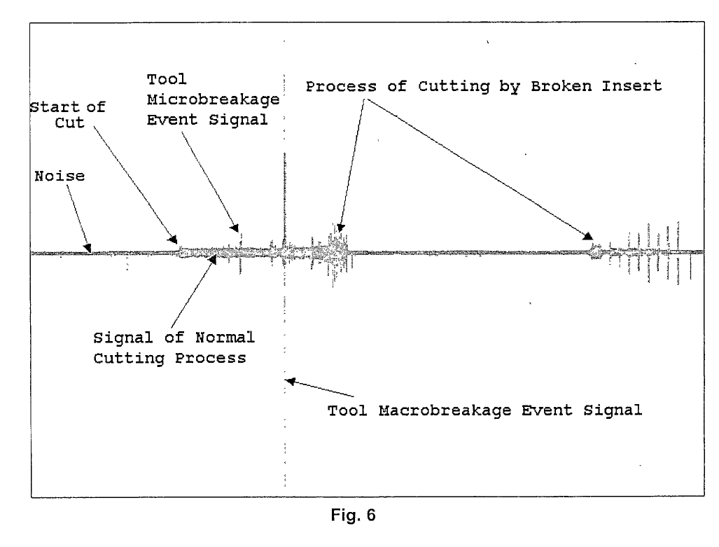

FIG. 6 illustrates electrical channel noise, start of cutting process, signal of normal cutting process, tool micro and macro breakage event signal, as well as signals of the process of cutting by broken insert, registered by measuring channel. Illustrating chart coordinate system: Y-signal amplitude, X-time (this axis is shown in compressed state).

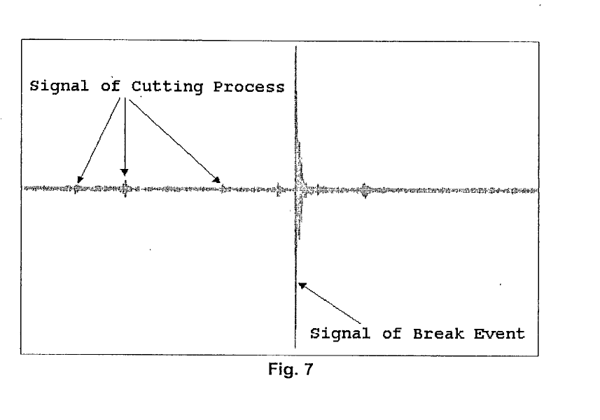

FIG. 7 shows cutting process in extended scale on X-axis (time). This chart illustrates separate cases of chip shaving, as well as tool breakage event.

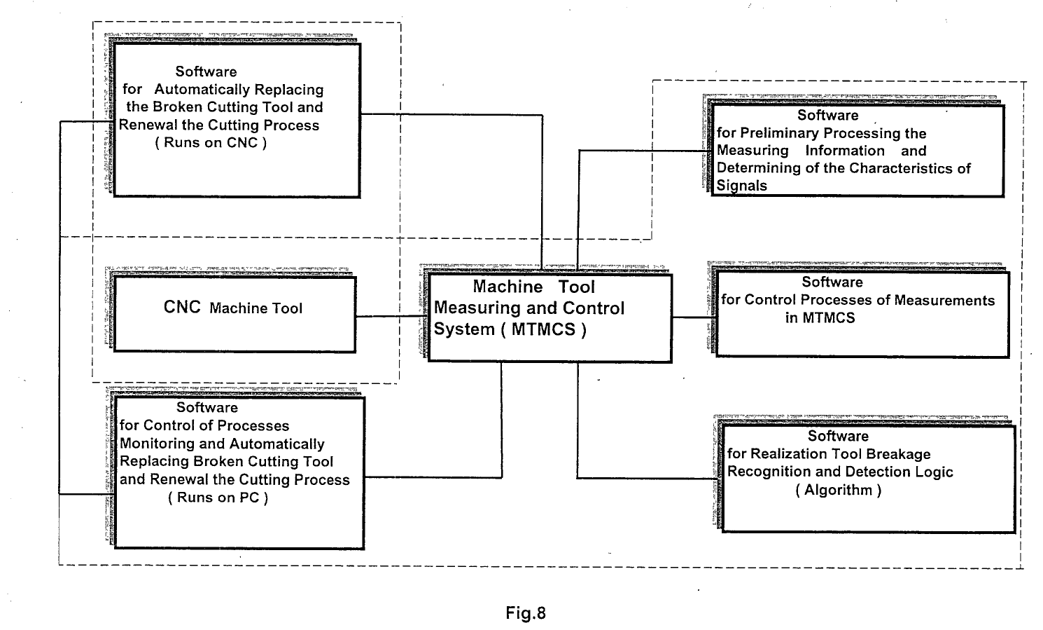

The system software assumes the functions of managing measuring and control systems, monitoring, signal identification, detection, etc. The system software also provides function of automatic retrieval of the broken tool, its replacement, and return to the cutting zone (refer to FIG. 8).

To supply the best values of signals, there is a program module to setup the optimal data buffer length and correspondent sampling frequency. The monitoring part of the software extracts the extreme value from each data buffer and then compares it with the given threshold values.

The executive part of the software contents two correspondents cooperatively running modules on the CNC and PC sides, and it provides memorizing the position of tool break, activates tool retract and recovery action, changes the broken tool for another similar tool, updates tool offset data, and resumes the cutting process.

A second aspect of the invention may be described as follows. This aspect relates to the manner of mounting and positioning the accelerometer in the machine-tool component, and in particular to the use of an accelerometer-mounting-transformer, to optimise the output-signal from the accelerometer.

In many cases, the component of the machine-tool in respect of which the invention may be applied comprises a relatively massive toolpost. In the case of a vertical boring machine, for example, the toolpost typically is a regular prism, standing vertically upright, being rectangular as to its cross-section, and typically is three or four metres long and around forty cm square. However, while a massive toolpost, especially a toolpost having an elongate, vertically prismatic configuration, is very well suited to the invention, it should be noted that the broad scope of the invention includes any machine-tool component in which vibrations and waves, especially acoustic waves, are propagated.

It is also an aim to sense the breakage event very quickly, preferably so quickly that the tool can be withdrawn before damage to the workpiece can occur. Indeed, it is an aim of the invention to sense and detect, from on-going analysis of the propagated waves, the precursors to the actual breakage event, in real time, in order that the tool may be withdrawn before the breakage occurs.

It is also an aim to provide a tool breakage detecting system that has a commercially valuable performance, with a manner of operation that is in keeping with the normal level of skill and expertise of persons who use machine tools.

One of the reasons it has taken the computer so long to determine that a tool-breakage has taken place, in the prior systems, is that it has been difficult to differentiate the tool-breakage signal from the normal-cutting signal. That is to say, in the prior art, the as-sensed vibrations caused by the breakage have not been greatly different from the as-sensed vibrations caused by normal cutting.

As a general principle, the more un-differentiated the tool-breakage signal is from the normal-cutting signal, the longer it takes, in milliseconds, before the signal processing computer can indicate that the breakage has taken place. It is not so much a question of computing speed; rather, when the amplitude of the event signal is not much greater than the amplitude of the normal signal, the signal sampling iterations that have to be performed by the computer take longer, and more iterations have to be processed, before the computer can be sure that an event has taken place.

On the other hand, computing speed is important. The indication that a breakage event has occurred will be delayed, perhaps for too long, if the computer cannot analyse the data quickly enough. Thus, the present invention really could not be contemplated, at least for the purposes of detecting the onset of a breakage event before it actually occurs, at least not in an economically-realisable form, with a computer having a CPU speed of less than about 500 MHz.

It is an aim of the invention to mount the accelerometer in such manner, using the accelerometer-mounting-transformer, as to permit the vibrations in the toolpost (or other component of a machine tool) to be sensed with a greater differentiation than has been the case hitherto between the normal-cutting signal and the tool-breakage signal. It is recognised that the greater this differentiation, the shorter the time it takes the computer to determine that a tool breakage event has taken place. This rapid determination can be utilised, for example, to initiate a rapid withdrawal of the broken tool from the workpiece, or otherwise to enable damage to the workpiece to be minimised.

There are many modes in which machine tool components vibrate. Any mode of movement in which the component can deflect elastically can potentially serve as a means for propagating vibrations and waves away from the cutting tool (or other vibration source). Of course, the designer of the machine tool will see to it that the toolpost is massive enough and rigid enough that mechanical displacement excursions due to vibration have very little amplitude.

Most of what may be termed the mechanically-simple vibrations occur at low frequency, at which there is a good deal of noise. So, the relatively-low frequency mechanical vibrations generally turn out to be quite unsuitable for picking out tool-breakage events. It is recognised that, with vibrations under about two kilohertz, it is practically impossible to pick out the change in amplitude resulting from a tool breakage event from the background noise. (The term “practically impossible” should be understood in the sense that such low-frequency vibrations are unlikely, in practice, to be able to serve as the basis for a commercially-reliable tool-breakage sensing system, which would have an acceptable performance at detecting breakage events.)

In some prior art systems, the preference has been to sense and analyse the higher-frequency vibrations, especially acoustic-mode vibrations, when seeking to detect tool-breakage events. The invention follows this preference, and is aimed mainly at utilising the higher frequency acoustic-mode waves that are being propagated in the toolpost when a cut is taking place.

The magnitude of the accelerations, as measured by the accelerometer, arising from these passing pulses, can be several G. In the type of machine-tool components in respect of which the invention may come to be considered, the acoustic (travelling-pressure-pulse) type of vibratory waves occur at frequencies in the five kilohertz to twenty-five kilohertz range, Acoustic waves travel through steel at speeds of around 5000 metres per second, and the wavelengths of the waves are in the range twenty to a hundred centimetres. The high frequencies of acoustic waves means that the waves are less noisy than the low-frequency mechanically-simple vibrations, which makes acoustic waves suitable for analysis for the purpose of detecting tool breakages, and acoustic waves have been used in some prior systems.

One of the aims of the invention is to utilise an accelerometer to detect acoustic waves propagating in the machine tool component, as in prior systems, but to mount the accelerometer on the component using the accelerometer-mounting-transformer, in such a manner that the output-signals from the accelerometer are clean and crisp, and very well discriminated. This means that the tool-breakage signals may be much better differentiated from the normal-cutting signal. In turn, this means that the signal analysis computer can detect that the tool-breakage event has taken place very rapidly. Typically, the breakage event can now be detected within about one millisecond. Indeed, many breakage events actually take more than one millisecond to be completed, and the event may be detected while it is occurring.

When breakage can be detected so rapidly, sometimes the tool can actually be withdrawn from the workpiece just at the onset of the breakage, before the breakage event has had time to cause anything but a slight blemish on the surface finish of the workpiece. A new tool can then be used to continue the cut. (Generally, of course, only machine-tools that have automatic tool-changing and tool-repositioning facilities would be fitted with, and operate in conjunction with, a tool-breakage-detection system of the type described herein.)

It is recognised that the acoustic waves being propagated in the toolpost (or other component of the machine-tool) travel through the body of the component and travel also along the surface. However, the waves actually on the surface of the component do not travel at the same speed as the waves being propagated internally. It is recognised that it is important, therefore, for the accelerometer that is sensing the waves to sense the waves either right at the surface of the component, or well inside the body of the component. If the accelerometer can pick up both the surface waves and some of the interior waves, propagating at their different speeds, the accelerometer will, in effect, take an average. If such averaging occurs, the clarity and sharpness of the output-signal will be spoiled, and sensitivity will be lost. One of the functions of the accelerometer-mounting-transformer is to make sure the accelerometer senses only the accelerations actually at the surface.

It is also recognised that it is important for the accelerometer to sense the accelerations only at the small localised point on the surface of the component at which the accelerometer is located. The accelerometer should not pick up accelerations over a wide or long portion of the surface area, surrounding the point, because the accelerations at the more remote points would be out of phase with the accelerations actually at the point, whereby again the accelerometer would take an average, leading to a deterioration in the clarity and sensitivity of the output-signal. Another of the functions of the accelerometer-mounting-transformer is to make sure the accelerator ignores accelerations occurring at points outside the small localised point of the surface of the component where the accelerometer is located.

Thus, it is recognised that the accelerometer should be so mounted as to pick up only the surface waves occurring at a small localised point on the surface, to avoid the accelerometer taking an average of the phases of the accelerations occurring at spaced-apart points on the surface.

The use of the accelerometer-mounting-transformer, as described herein, enables these precautions and constraints to be applied and followed. Generally, they have not been followed in the prior art systems.

It is recognised that the surface of the machine-tool component, in respect of which surface-waves are being measured, should be planar, and preferably should be flat and smooth. If the surface were rough, the surface-waves would tend to be noisy and indistinct, and it would be difficult to mount the accelerometer to the rough surface so as to pick up the surface-waves. The smooth surface preferably should extend several centimetres around the attachment point, preferably fifteen centimetres or more in the direction of wave propagation.

It is also recognised that the accelerometer should be mounted at a location on the toolpost where the waves are not being subjected to reflections and interferences. The surface of the toolpost should be planar, where the accelerometer is located. It is not essential that the plane of the surface be perfectly flat, but there should be no sudden steps or breaks in the surface, near the accelerometer. Steps cause reflections, and the reflected wave will not be in phase with the originating wave. So, the accelerometer should be placed far enough away from any steps or other discontinuities that the amplitude of waves reflected therefrom is insignificant.

It is also recognised that if the accelerometer, and/or the accelerometer-mounting-transformer, were to be set into a cavity in the surface, e.g a machined cavity, with machined corners, the cavity might itself act as a source of reflected waves. The reflected waves would be out of phase with the originating wave, and might be detected by the accelerometer, to the detriment of the clarity of the output-signal. It is recognised, for example, that screw-holes in the surface, which the designer might contemplate providing for bolting the accelerometer to the surface, should be avoided, as such holes might give rise to spurious out-of-phase reflections, which might have enough amplitude to be detected by the accelerometer.

It is also recognised that the accelerometer-mounting-transformer should be so positioned as to hold the accelerometer aligned with the direction in which the waves are propagating along the surface of the component. If the accelerometer were to be misaligned at an angle of more than about ten degrees away from the direction of the wave propagation, the quality of the output-signal would start to deteriorate.

Thus, it is recognised that the designer should have the following points in mind, in the design of the accelerometer-mounting-transformer:

a) the accelerometer should be mounted on the toolpost or other component of the machine tool such that the accelerometer measures only the surface waves;

b) the accelerometer should measure the surface waves only at a single localised point on the surface of the toolpost;

c) in the vicinity of the accelerometer, the surface of the toolpost should be planar, i.e the surface should be free of steps, breaks, and the like;

d) in the vicinity of the accelerometer, there should be no machined cavity, or other feature, on or in the surface of the toolpost, which might give rise to out-of-phase wave-reflections, or to any other spurious emanations that might have a measurable amplitude at the frequency of the originating wave, and which might therefore spoil the crispness of the output-signal.

e) the accelerometer should be aligned/orientated with the direction of the propagation vector of the acoustic surface waves at the location of the accelerometer.

When these precautions are taken, it can be the case that the amplitude of the measured accelerations, during normal cutting, are in the 2-G to 5-G range, as signalled to the computer, whereas the amplitude of the vibrations, as signalled for a period of a few milliseconds, during a tool-breakage event, are 20-G or more. These amplitude differences are so large that a computer analysis program can pick up the difference almost instantly, i.e perhaps within one vibratory cycle, and certainly in less than one millisecond. It is recognised that it is the fact that the accelerometer is mounted in the manner as described herein that gives rise to the output signal being sufficiently crisp and clear for this difference in amplitude to be so marked. It is the large difference in amplitude between the normal-cutting signal and the tool-breakage-event signal that permits the breakage event to be detected so quickly.

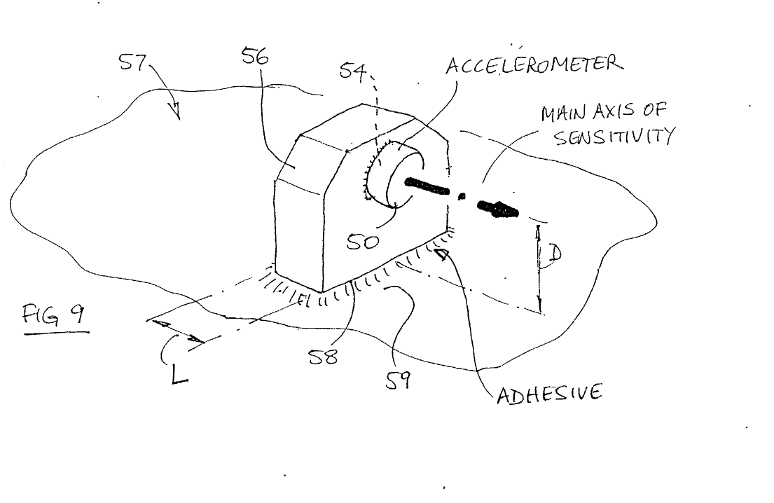

Suitable accelerometers for use in the wave analysis systems as described herein are readily available, in a number of proprietorial forms. A typical accelerometer 50 (FIG. 9) includes a (typically piezo-electric) transducer 54, the output voltage of which is proportional to the magnitude of the acceleration.

Generally, an accelerometer has a main axis of sensitivity. The signal-response of the accelerometer, i.e the amplitude of output-signal corresponding to an applied acceleration of given magnitude, is a maximum when the acceleration is applied along that axis. The main axis of sensitivity may be marked on the fixed body of the accelerometer by the manufacturer. If it is not marked, the user still needs to know where the axis lies; if the user has no other way of finding out, they should conduct tests to determine the main axis of sensitivity of a particular accelerometer.

The accelerometer is mounted in the accelerometer-mounting-transformer 56. It is the function of the accelerometer-mounting-transformer to mount and hold the accelerometer in such a manner, relative to the machine-tool component 57, that the above-described aspects that affect the clarity and quality of the accelerometer's output-signal can all be optimised. The accelerometer-mounting-transformer holds the accelerometer in the manner that will best ensure that the acoustic waves emanating from the tool-tip are picked up, and transferred as voltage signals to the computer, with maximum amplitude and with minimum noise, distortion, and interference.

The accelerometer-mounting-transformer 56 should be a rigid structure, in itself. For example, the accelerometer-mounting-transformer comprises a single block of metal, of a chunky shape. The fixed body of the accelerometer is rigidly attached to the accelerometer-mounting-transformer. Thus, any accelerations undergone by the accelerometer-mounting-transformer are transmitted completely, i.e without loss of amplitude and without change of phase, directly to the fixed body of the accelerometer.

The accelerometer-mounting-transformer has a fixing-face 58, by means of which the accelerometer-mounting-transformer is attached to the planar-surface 59 of the component 57. Preferably, the fixing-face is glued to the planar-surface. The accelerometer-mounting-transformer might be attached with screws, or the like, but the designer should have in mind the possibility that the screws might introduce reflected-wave sources, which might spoil the output-signal.

Apart from not introducing spurious wave-sources, and whatever means is selected for attaching the fixing-face of the accelerometer to the planar-surface, the result should be that the accelerometer-mounting-transformer and the point on the planar-surface to which it is attached should undergo identical accelerations in unison. That is to say: the designer should aim for the fixing-face to undergo exactly the same accelerations, as to amplitude and phase, as the point on the planar-surface. Both the accelerometer-mounting-transformer and the manner of fixing the accelerometer-mounting-transformer to the planar-surface of the component must be so structured as to be rigid, i.e rigid in the sense that the fixed-body of the accelerometer should undergo the same accelerations as the point on the planar-surface, in amplitude and phase, at least up to the frequencies of the acoustic waves propagating on the surface of the component. The accelerometer-mounting-transformer preferably should have a frequency response that is high enough to permit the accelerometer to operate through its whole frequency response range. Also, the manner in which the accelerometer-mounting-transformer is secured to the planar-surface (e.g by adhesive) should not introduce a lack of rigidity that might detract from the frequency response. As mentioned, responsiveness up to fifty kHz is preferred; twenty-five kHz may be regarded as the lower limit.

As to its particular structure, the accelerometer-mounting-transformer has the following characteristics:

a) the accelerometer-mounting-transformer has a fixing-face by which it is attached to the planar-surface of the component;

b) the accelerometer-mounting-transformer, attached through its fixing-face to the planar-surface, holds the accelerometer rigidly, with its sensitivity axis parallel to, and spaced a distance D out from, the planar-surface of the component;

c) the accelerometer-mounting-transformer, attached through its fixing-face to the planar-surface, holds the axis of the accelerometer aligned in the direction in which surface-waves are propagated along the planar-surface.

In a side-view of the accelerometer-mounting-transformer, i.e a view parallel to the planar-surface, the accelerometer-mounting-transformer holds the accelerometer with its axis parallel with the planar-surface, the axis being spaced a stand-off distance D from the planar-surface. The stand-off distance D may be in the region of one or two centimetres, for example.

As mentioned, the area of the fixing-face should not be large. If the area were large, the accelerometer might pick up not-in-phase portions of the wave, and might start to sense the average of these portions. Rather, the fixing-face should be small, so that the accelerations as picked up by the accelerometer include no out-of-phase components. Of course, the fixing-face theoretically would have to be of infinitesimal area to be completely free from out-of-phase components; but in practical terms, so long as the overall dimensional extent of the fixing-face is much smaller the wavelength of the waves, phase-averaging will be insignificant. Preferably, therefore, the dimensional extent of the fixing-face, especially along the line of the wave propagation vector, should be only a few centimetres, i.e less than five centimetres, and preferably less than two centimetres. The frequency (and wavelength) of the vibratory waves being monitored is not always the same, of course, being variable, for instance, in proportion to the cutting speed at which the machine-tool is operating.

The accelerometer-mounting-transformer must be rigid, and must be rigidly attached through its fixing-face to the planar-surface. A structural element may be regarded as rigid, in the context of the invention, if the element transmits accelerations without loss of amplitude and without change of phase. Of course, theoretically, nothing is perfectly rigid, and the term should be construed in the sense that the element is rigid where such losses or changes are insignificant.

Generally, the smaller the accelerometer-mounting-transformer, the more rigid it may be expected to be. So, the stand-off distance D should be small, as mentioned; if the standoff distance were large, the fixing face might also then have to be (detrimentally) enlarged, in order for the accelerometer-mounting-transformer to meet the required standard of rigidity.

In order for the accelerometer to pick up the acoustic surface waves to best advantage, it is also recognised that the accelerometer should be aligned with the direction in which the waves are propagating along the surface. Thus, in a plan view (i.e a face-on view) of the planar-surface, the acoustic waves are propagated along a line, that line being termed the wave-propagation-vector. If the cutting tool is located at one end of a regular, long, prismatic, toolpost (like the ram of a vertical boring machine), with smooth surfaces, it can be expected that the vector along which the surface waves propagate over the surface will be more or less parallel to the long axis of the toolpost. When the toolpost is some other shape, the direction of the vector may be determined by calculation. However, machine-tool components often are regular. In many cases, a skilled expert can make a reasonable estimation, by inspection, as to the direction of the wave-propagation-vector, without having to resort to the sometimes difficult calculations.

The accelerometer, being placed at a point on the surface of the toolpost, should be aligned, at that point, along the line of the wave-propagation-vector at that point. Sometimes, it will be appropriate for an initial approximate alignment to be done by inspection or calculation; technicians may then fine-tune the alignment, by checking various possible alignments, and selecting the alignment which yields the greatest amplitude of output-signal for a given level of cutting.

In the case of a machine-tool that is being produced in numbers, the best alignment for the accelerometer need be determined only once. The individual machines may be expected to have their accelerometers slightly mis-aligned, but the mis-alignment would hardly be so large as to be significant. The accelerometer-mounting-transformer, at its point of attachment to the planar-surface, should be aligned with the axis of the accelerometer within ten degrees of the line of the wave-propagation-vector at that point. In other words, for a given level of vibrations emanating from the tool-tip, the accelerometer-mounting-transformer, at its point of attachment to the planar-surface, should be aligned with the axis of the accelerometer within ten degrees of the line at which the amplitude of the measured accelerations are at a maximum.

A small misalignment or mis-orientation of the accelerometer axis does not matter, but if the mis-orientation were more than about ten degrees, the loss of amplitude, and the possible sensing of unwanted reflections and of other portions of the waves, might be no longer insignificant.

The mis-orientation mentioned above is mis-orientation as measured in a plan view of the planar-surface with the accelerometer attached thereto. The same points should be understood as being applicable also if the accelerometer axis were not parallel to the planar-surface as measured in the side elevation, i.e if the stand-off distance D were to vary. But of course, there is no problem ensuring the accelerometer is mounted with its axis accurately parallel to the planar surface, in side view, whereas, in some case, there might be some difficulty ensuring the accelerometer is mounted with its axis aligned with the wave-transmission-vector, in plan view.

A simple preliminary approximation to placing the accelerometer in the correct alignment, relative to the wave-propagation-vector, may be obtained by aligning the axis of the accelerometer, at the point of attachment, with a line drawn from the tool-tip to the point of attachment. At least when the toolpost or other component is regular as to its shape, the actual vector may be expected to run close to this line.

The accelerometer and the accelerometer-mounting-transformer should be mounted, on the planar-surface of the component, close to the source of vibration. The further away the attachment point from the source, the more the waves become attenuated. On the toolpost of a vertical boring machine, for example, the accelerometer preferably should be no more than about one metre from the tool-tip. Of course, the designer must see to it that the accelerometer is protected from being physically knocked, etc, during use (and servicing) of the machine-tool.

The surface waves as detected by the accelerometer may be analysed for purposes other than detecting tool breakage. For example, it may be expected that each machine-tool will have a characteristic wave profile, even when the machine, though running, is not taking a cut. This characteristic profile may be analysed periodically, to check whether e.g a fault might have developed in the slides and bearings of the machine-tool. Alternatively, sometimes, the waves can be analysed to check for cyclic variations per revolution of the workpiece, which might serve to indicate that the workpiece was not running true.

The surface-wave analysis system described herein does not work on some machine-tools. Sometimes, the shape of the component, the nature of its surface, the distance the accelerometer has to be mounted away from the source, the types of cuts being made, etc, mean that no matter how the accelerometer may be orientated, where it can be located, no useful signal emerges. In some cases, it may be necessary to carry out some trial and error experiments. The experimenter would attach the accelerometer, in its accelerometer-mounting-transformer, to a suitable-seeming planar surface of the component, and experiment with orientating the accelerometer at that location.

It may be noted that a cutting tool that was mounted in bearings, for rotation, in the toolpost, probably could not be classed as rigidly attached to the toolpost, in the context of the invention. Preferably, the cutting tool should be clamped very tightly to the toolpost to be so classed. The actual clamping structure (which usually includes clamping bolts) might introduce spurious reflected waves. Therefore, the accelerometer should be away from the actual tool and its clamps, whereby the spurious waves will have died away to negligible levels, whereby the sensor picks up just the waves emanating from the interface between the cutting tool and the workpiece.

1. Apparatus for processing vibratory waves in a component of a machine-tool, wherein:
the machine tool includes a source of vibration, which is so disposed in the machine-tool as to cause vibratory waves to be propagated along a planar-surface of the component;
the apparatus includes an accelerometer, which is coupled to a computer, which is programmed to receive and analyse output-signals from the accelerometer;
the accelerometer has a main axis of sensitivity;
the apparatus includes a accelerometer-mounting-transformer, to which is mounted the accelerometer;
the accelerometer-mounting-transformer has a fixing-face by which it is attached to the planar-surface of the component, at an attachment-zone on the planar-surface;
the accelerometer-mounting-transformer is rigid in itself, and is rigidly attached to the accelerometer and is rigidly attached to the attachment-zone on the planar-surface;
the accelerometer-mounting-transformer, attached through its fixing-face to the attachment-zone on the planar-surface, holds the accelerometer with its axis spaced a distance D out from the planar-surface;
the accelerometer-mounting-transformer, attached through its fixing-face to the attachment-zone on the planar-surface, holds the axis of the accelerometer in substantial alignment with the direction in which surface-waves are propagated along the planar-surface.

2. Apparatus of claim 1, wherein:
the accelerometer, so held, has a signal-response, being the amplitude of the output-signals in response to the surface-waves propagated along the planar-surface of the component, and the structure of the apparatus is such that the amplitude of the signal-response would vary responsively if the orientation of the accelerometer-mounting-transformer on the planar-surface were to vary;
and the accelerometer-mounting-transformer holds the axis of the accelerometer aligned at that orientation on the planar-surface in which the signal-response is a maximum.

3. Apparatus of claim 1, wherein the planar-surface of the component, over an area that includes the attachment-zone, is uninterruptedly smooth and flat, and the component is so free from steps, discontinuities, and other sources of reflected waves, that no significant amplitude of reflected waves can be detected at the accelerometer.

4. Apparatus of claim 1, wherein the fixing-face, as to its dimensions overall, is at least an order of magnitude smaller than the wavelength of the said surface-waves.

5. Apparatus of claim 1, wherein the accelerometer-mounting-transformer holds the axis of the accelerometer so orientated, on the planar surface, as to be at least approximately co-linear with a line drawn from the source of vibration along the planar-surface to the attachment-zone.

6. Apparatus of claim 1, wherein the nature of the machine tool is such that the vibration waves are acoustic waves in the frequency range five to twenty-five kilo-Hertz.

7. Apparatus of claim 1, wherein the source of vibration comprises the cutting interface between a cutting-tool tip and a workpiece.

8. Apparatus of claim 7, wherein:
the said component of the machine-tool is a massive unitary toolpost, the configuration of which is such that the toolpost may be characterised as elongate, having a lengthwise axis that is a straight line;
the arrangement of the machine-tool is such that the line of the lengthwise axis of the toolpost passes through, or passes close to, the said cutting interface;
and the axis of the accelerometer points towards the cutting interface.

9. Apparatus of claim 8, wherein the structure of the machine-tool is such that the cutting tool is rigidly attached to the massive toolpost, being attached so rigidly that acoustic vibrations emanating from the cutting interface are transmitted with minimal attenuation into the toolpost.

10. Apparatus of claim 9, wherein the toolpost, to which the tool is rigidly attached, and to which the accelerometer is rigidly attached by the accelerometer-mounting-transformer, is a massive unitary rigid block of metal, and is at least one meter long.

11. Apparatus of claim 1, wherein the accelerometer-mounting-transformer, attached via its fixing-face to the attachment-zone on the planar-surface, holds the accelerometer with its axis parallel to the planar-surface.

12. Apparatus of claim 11, wherein the stand-off distance D is less than about two centimetres.

13. Apparatus of claim 1, wherein:
the accelerator-mounting-transformer comprises a small, rigid block of metal;
the accelerometer includes a fixed housing structure, which is rigidly attached into the block;
and the accelerometer-mounting-transformer is attached through its fixing-face to the attachment-zone on the planar-surface, in that the rigid block is glued rigidly to the planar surface.

14. Apparatus of claim 1, wherein the length of the area of the fixing-face over which the fixing face is rigidly attached to the attachment-zone of the planar-surface, is no more than about five centimetres, as measured in the direction in which surface-waves are propagated along the planar-surface.

15. Apparatus of claim 1, wherein, at the attachment-zone, and for an area of several centimetres around the attachment-zone, the planar-surface of the component is flat and smooth, and any steps or other discontinuities in the said area are so small that the amplitude of waves reflected therefrom is insignificant.

16. Apparatus of claim 1, wherein the component having the planar-surface is of such physical size, and shape, that acoustic-frequency waves can be transmitted along the planar-surface.

17. Procedure of claim 1, wherein the accelerometer-mounting-transformer itself has a frequency response greater than about twenty-five kilo-Hertz.

18. Procedure of claim 17, wherein the accelerometer and the accelerometer-mounting-transformer, together, as a mechanical assembly, have a frequency response greater than about twenty-five kilo-Hertz.

19. Procedure for processing vibrations in a component of a machine tool, wherein the machine tool includes a source of vibration, which is so disposed in the machine tool as to cause vibratory waves to be propagated along a planar-surface of the component, and the procedure includes:
providing an accelerometer, having an axis of sensitivity;
coupling the accelerometer to a computer, and programming the computer to receive and analyse output signals from the accelerometer;
providing an accelerometer-mounting-transformer, and securing the accelerometer rigidly thereto;
wherein the accelerometer-mounting-transformer has a fixing-face, and is so structured that the fixing-face lies in a plane that is parallel to the axis of sensitivity of the accelerometer;
attaching the accelerometer-mounting-transformer, by its fixing-face, rigidly to a first attachment-zone on the planar-surface;
whereby the axis of the accelerometer lies at a first orientation relative to a line drawn on the planar-surface;
measuring a first signal-response of the accelerometer, being the amplitude of the output-signal responsive to a given level of vibrations at the source, with the axis of the accelerometer at that first angle of orientation;
attaching the accelerometer-mounting-transformer at further additional orientations on the planar-surface, and measuring the signal-responses thereat;
and attaching the accelerometer rigidly to the planar-surface at the orientation in which the as-measured signal-response was a maximum.

20. Method of measuring vibratory waves, for identification and control of mechanical systems or their components, comprising:
mounting a sensor in a sensor-mounting-transformer and mounting the sensor-mounting-transformer on the surface of an element of the mechanical system;
orientating the sensor so that its main axis of sensitivity coincides with the direction of propagation of the vibratory waves;
processing electrical signals from the sensor, according to an algorithm.

21. Method of claim 20, wherein:
the method is used to detect a metal cutting tool breakage event during cutting;
the method includes using the sensor to provide an electrical signal from the cutting tool, during cutting;
the structural arrangement of the mechanical system is such that the sensor senses acoustic waves and vibrations emanating from the interface between the cutting tool and the workpiece.

22. Method of claim 21, including:
operating a metal cutting machine having a cutting tool;
attaching the sensor to the metal cutting machine;
commencing a metal cutting procedure;
sensing stages of metal cutting procedures with changing parameters such as surface speed, depth of cut, feed rate;
collecting data from the sensor;
carrying out experiments, to build up data relating to breakage events, and comparing such data with data relating to normal cutting;
thereby determining a threshold value for the magnitude of the signal, which indicates that a tool breakage event has taken place;
analyzing the signal as detected by the sensor, during cutting, and determining the amplitude of the signal, on an on-going basis, and comparing that amplitude with the pre-determined threshold that defines whether a tool breakage event has occurred.

23. Method of claim 22, including making a determination as to two thresholds, indicating respectively micro-breakage and macro-breakage events.

24. A machine tool monitor for detecting, in real time, a cutting tool breakage event, while machining a work piece, comprising:
a broadband measuring sensor, which generates an electrical signal representing mechanical vibrations at the interface of cutting-tool and workpiece;
a signal processor, having filters to attenuate machinery noise, electrical noise in measurement channels, and the like;
digital circuitry, for processing the signals and for generating tool breakage alarms.

25. A machine tool monitor for detecting, in real time, a cutting tool breakage event, while machining a work piece, comprising:
real-time acoustic waves and vibrations measuring expert and control system for detecting tool breakage while machining a work piece comprising:
measuring converter sensitive to mechanical processes at the “tool-work piece” interface, and tool processes, and is positioned on an element of mechanical system with distributed parameters to convert mechanical processes to electrical signals;
an analog processor for filtering said signals;
digital means to detect tool breakage events capable of marring the work piece and prevent false alarms on minor tool breakage events spurious signals noise;
means for sampling the output signals of said analog processing means and converting each samples to digital form and a digital processor to detect cutting condition changes in real-time that can damage the work piece;
tools for definition of the best values of signal;
tools for setting and activation threshold values for detecting micro- and macro-tool breakage;
setting and interpreting different reaction types on tool breakage and wear events:
warning operator message:
automatically tool retract and recovery;
resume the cutting process from the cycle of tool breakage with another tool.
